(19) United States
(12) Patent Application Publication
(10) Pub. No.: US 2007/0028806 A1
(43) Pub. Date: Feb. 8, 2007

(54) Coating compositions having improved appearance containing coated titanium dioxide pigments

(76) Inventors: Bonnie D. Piro, Swedesboro, NJ (US); William F. Graham, Wayne, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/451,788

(22) Filed: Jun. 13, 2006

Related U.S. Application Data
(60) Provisional application No. 60/705,013, filed on Aug. 3, 2005.

(51) Int. Cl. C09C 1/36; C08K 9/00

(52) U.S. Cl. 106/446; 523/200; 524/497

(57) ABSTRACT

The present invention is directed to a coating composition comprising a film forming binder and coated titanium dioxide pigment in a pigment to binder weight ratio in the range of from about 0.1:100 to about 300:100;

wherein the TiO₂ Pigments comprise titanium dioxide first coated with silica in the presence of citric acid and having a second coating of alumina; whereby a cured finish resulting from the coating composition over a substrate has a wave scan R value of at least 6.3 gloss when applied at 27° C. and 85% relative and also has reduced haze and improved gloss retention; other aspects of this invention are tints that are formulated with the above titanium dioxide coated pigments that have excellent shelf life and a process for applying the coating composition to substrates.

### CROSS REFERENCE TO RELATED APPLICATIONS

This application claims the benefit of U.S. Provisional Application Ser. No. 60/705,013 filed on Aug. 3,2005 which is hereby incorporated by reference.

### BACKGROUND OF THE INVENTION

This invention relates to coating compositions containing coated titanium dioxide pigments having improved appearance and gloss retention when applied under high humidity and temperature conditions.

### DESCRIPTION OF THE PRIOR ART

Titanium dioxide pigments have a high level of opacity and have been widely used to provide high quality white coating compositions (paints) and are used in tints and toners used in formulating colored coating compositions. To improve titanium dioxide pigments, e.g., dispersibility, of the pigments, the pigments have been coated, e.g., with silica and alumina as shown in U.S. Pat. No. 3,437,502. Improvements in the process for the coating of titanium dioxide pigments with a first coating of silica in the presence of citric acid and with a second coating of alumina are shown in U.S. Pat. No. 6,783,586. These titanium dioxide pigments made according to the process of U.S. Pat. No. '586 hereinafter will be referred to as “TiO₂ Pigments”. There is a need for coating compositions that form finishes that have improved appearance, such as, gloss and DOI (distinctness of image) particularly for vehicle coatings meaning automobile and truck coatings and that are resistant to the degradation caused by high humidity and exposure to outdoor weathering. Also, there is a need to form tints that are supplied, for example, to auto and truck refinish shops, that have improved shelf life, such as, two years and over.

It was surprising and unexpected to find that finishes formed from coating compositions containing TiO₂ Pigments that have the improved coating of silica and alumina prepared according to U.S. Pat. No. 6,783,586 have improve appearance, in particular, gloss and DOI, improved wave scan results and in particular improved gloss retention when applied under conditions of high humidity and relatively high temperatures in comparison to coating compositions containing titanium dioxide pigments having the similar silica/alumina coatings that were prepared according to prior art methods. Also, tints can be formed with these TiO₂ Pigments that surprisingly have improved shelf stability in comparison to prior art titanium dioxide pigments.

### SUMMARY OF THE INVENTION

The present invention is directed to a coating composition comprising a film forming binder and TiO₂ Pigments in a pigment to binder weight ratio in the range of from about 0.1:100 to about 300:100;

wherein the TiO₂ Pigments comprise titanium dioxide first coated with silica in the presence of citric acid and having a second coating of alumina;

whereby a cured finish resulting from the coating composition over a substrate has a wave scan R value of at least 7 when the coating composition is applied at 27° C. and 85% relative humidity and also has reduced haze and improved gloss retention.

Other aspects of this invention are tints that are formulated with the above titanium dioxide coated pigments that have excellent shelf life and a process for applying the coating composition to a substrate.

### DETAILED DESCRIPTION OF THE INVENTION

The features and advantages of the present invention will be more readily understood, by those of ordinary skill in the art, from reading the following detailed description. It is to be appreciated those certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about.” In this manner, slight variations above and below the stated ranges can be used to achieve substantially the same results as values within the ranges. Also, the disclosure of these ranges is intended as a continuous range including every value between the minimum and maximum values.

All patents, patent applications and publications referred to herein are incorporated by reference in their entirety.

The coating compositions of this invention can be solvent borne or water borne solutions or dispersions, high solids compositions, powder coatings or aqueous electrodeposition coatings. One typically coating composition of this invention is a solvent-borne coating compositions, particularly, a pigmented solvent-borne paint composition used for OEM painting or for refinishing or repainting the exterior of automobiles and trucks and parts thereof. The coated titanium dioxide pigment in the coating composition provides a Class A automotive finish having an excellent overall appearance, good DOI excellent gloss retention under high temperature and humidity conditions. The coated titanium dioxide pigment also can be used in automotive quality primers, primer surfacers and primer fillers and for a large variety of industrial coatings and architectural coatings.

“Wave scan” is determined with a wave scan measuring instrument, such as, a Byk Wave Scan Plus instrument, Model No. 4812 manufactured by the Byk Gardner Corporation located Columbia, Md., USA. The instrument measures the appearance of surface changes with the size and distinctness of structures. Structures are perceived as being very distinct, e.g., an edge is reflected on the surface with high contrast and sharpness. The instrument evaluates structure size as well as the brilliance of the surface. There is a high correlation to visual viewing of the surface by analyzing the structure size using ultra short and ultra long wave lengths. Reproducible results are provided on curved and flat test panels and for solid and metallic coatings. Acceptable finishes have a wave scan R value of at least 7 and preferably in the range of 8.0-9.8. A perfect wave scan R value is 10.

“Gloss retention” is the level of gloss retained after a finish of a coating composition has been applied under high humidity and temperature conditions, typically, 27° C. (80° F.) at 85% relative humidity Coating compositions formulated with TiO₂ Pigments have a gloss retention level of 80% and preferably 90%. In comparison, coating compositions formulated with conventional prior art titanium dioxide pigments have a lower level of gloss retention when applied under these conditions.

Surprisingly, tints formulated with the TiO₂ Pigments have excellent shelf life, for example, at least two years and above.

“Tints” are aqueous or solvent based pigment dispersions that contain pigments, typically white pigments, such as, TiO₂ Pigments, optionally, other color producing pigments and a pigment dispersing resin which may also be a binder resin for a coating composition and these tints are used to formulate coating compositions of a desired color.

A typical coating composition formulation consists of various tints in given amounts, solvents and binder and other additives that are thoroughly blended together to form a paint composition.

“Shelf life” is the time period in which a coating composition or a tint remains in its useful state, i.e., the coating composition remains at a sprayable viscosity or the tint remains blendable with other constituents to form a coating composition and the pigment does not settle or separate in the tint.

The term “binder” as used herein refers to the film forming constituents of a coating composition and includes any crosslinking components, such as, polyisocyanates, optional polymeric and/or oligomeric components, and optional reactive diluents. Solvents, water, pigments, catalysts, antioxidants, U.V. absorbers, light stabilizers, leveling agents, antifoaming agents, anti-cratering agents, adhesion promoting agents are not included in the term.

The binder of the novel coating composition can be any of those binders that are typically used in automotive, refinish, industrial and architectural coatings and are described herein after.

These coating compositions may contain pigments other than TiO₂ Pigments, in particular colored pigments, metal flakes, special effects pigments, like coated flakes and metal powders. The coating compositions can be lacquers or crosslinkable compositions.

“Lacquer” is a coating composition that dries via solvent evaporation without any substantial crosslinking of the binder of the coating composition.

The TiO₂ Pigments are used in the coating composition in a pigment to binder ratio (weight ratio) in the range of from about 0.1:100 to about 300:100, preferably in pigment to binder ratio in the range of from about 1:100 to about 200:100.

The TiO₂ Pigments are formed by coating untreated titanium dioxide pigments sequentially with a hydrous silica and hydrous alumina using a process described in U.S. Pat. No. 6,783,586 that uses citric acid in the process. Preferably, the TiO₂ Pigments contain from 3 to 6% by weight of silica glass and from 1 to 4% by weight of amorphous alumina, based on the weight of the untreated titanium dioxide pigments.

The use of the TiO₂ Pigments in coating compositions, provides finishes on curing that have improved appearance, e.g., gloss, DOI, wave scan and reduced haze and in particular have improved gloss retention when applied under high humidity and temperature conditions.

Typically, coating compositions comprise 5 to 95 percent by weight of a carrier, which can be a solvent, non-solvent, or an aqueous carrier, based on the weight of the coating composition, and 5 to 95 percent by weight of a binder and contains the TiO₂ Pigments in the pigment to binder ratios disclosed above.

Molecular weight (both number and weight average) is determined by gel permeation chromatography utilizing a high performance liquid chromatograph supplied by Hewlett-Packard, Palo Alto, Calif. and unless otherwise stated the liquid phase used was tetrahydrofuran and the standard was polymethylmethacrylate or polystyrene.

“Tg” (glass transition temperature) is in ° C. and determined by Differential Scanning Calorimetry or calculated according to the Fox Equation.

The following are examples of typical binders used in the novel coating composition: acrylic polymers, such as, poly(meth)acrylates, meaning both polyacrylates and poly(meth)acrylates, branched, grafted or segmented poly(meth)acrylates, polyacrylourethanes, polyesters, branched copolyesters, oligomers, e.g., urethane oligomers, polyester urethanes, polyepoxides and carbamate functional polymers.

Generally, these binders contain moieties that are reactive with typical crosslinking agents used for coating compositions. Typical moieties are hydroxyl, carboxyl, anhydride, glycidyl, primary amino groups, secondary amino groups, acetoacetoxy moieties and ketimine moieties.

Typical crosslinking agents that may be used in these compositions are polyisocyanates, blocked polyisocyanates, melamine crosslinking agents, alkylated melamines, silanes, benzoguanamines, epoxides, ketimines, polyamines, polyacids and other crosslinking agents known to those skilled in the art.

As is known to those skilled in the art, the binder with at least one reactive moiety is matched with the appropriate crosslinking agent to provide a coating composition with the desired rate of curing and the desired final properties of the cured composition. The following are typical useful combinations of binders and crosslinking agents that are useful:

Hydroxy containing binders, such as acrylic polymers, polyesters, polyesterurethanes, acrylourethanes can be crosslinked with melamines, alkylated melamines, polyisocyanates, benzoguanamines, silanes and appropriate mixtures of such crosslinking agents.

Binders, like acrylic polymers, containing acetoacetoxy groups can be crosslinked with ketimines.

Binders containing primary and or secondary amines or ketimine groups can be crosslinked with polyisocyanates.

Binders containing carboxyl, anhydride, or primary and or secondary amines can be crosslinked with monomeric or polymeric epoxide crosslinking agents.

Binders containing acetoacetoxy or epoxy moieties can be crosslinked with polyamines.

Binders containing glycidyl or epoxy groups can be crosslinked with polyacid crosslinking agents.

The acrylic polymers used to form the novel coating composition of this invention may be random polymers or structured copolymers, such as, block or graft copolymers. Particularly useful structured polymers are branched acrylic polymers having segmented arms as disclosed in U.S. Ser. No. 10/983,462 filed Nov. 8, 2004 and U.S. Ser. No. 10/983,875 filed Nov. 8, 2004.

A block copolymer that may be used in the present invention can have an AB diblock structure, or ABA or ABC triblock structure, for example. Graft copolymers can be used in the present invention having a backbone segment and a side chain segment(s). Random copolymers that can be used have polymer segments randomly distributed in the polymer chain.

Acrylic AB, ABA or ABC block copolymers can be prepared by using a stepwise polymerization process such as anionic, group transfer polymerization (GTP) taught in U.S. Pat. No. 4,508,880, Webster et al., “Living polymers and process for their preparation”, atom transfer radical polymerization (ATRP) taught in U.S. Pat. No. 6,462,125, White et al., and radical addition fragmentation transfer (RAFT) taught in U.S. Pat. No. 6,271,340, Anderson, et al. “Method of controlling polymer mole weight and structure”. All of the above are herein incorporated by reference. Polymers so produced have precisely controlled molecular weight, block sizes and very narrow molecular weight distributions.

Graft copolymers useful in the novel coating composition may be prepared by a macromonomer approach using the special cobalt chain transfer (SCT) method reported in U.S. Pat. No. 6,472,463, Ma, the disclosure of which is herein incorporated by reference.

Random copolymers can be prepared using conventional free radical polymerization techniques as described in U.S. Pat. No. 6,451,950, Ma, the disclosure of which is herein incorporated by reference.

Typically useful acrylic polymers have a number average molecular weight of about 1,000 to 100,000, a Tg of 10 to 100° C. and contain moieties, such as, hydroxyl, carboxyl, anhydride, glycidyl, primary and or secondary amino groups, acetoacetoxy moieties and ketimine moieties. Typically useful acrylic polymers are known in the art and the following are typical examples of monomers used to form such polymers: linear alkyl (meth)acrylates having 1 to 12 carbon atoms in the alkyl group, cyclic or branched alkyl (meth)acrylates having 3 to 12 carbon atoms in the alkyl group including isobornyl (meth)acrylate, hydroxy alkyl (meth)acrylates having 1 to 4 carbon atoms in the alkyl group, glycidyl (meth)acrylate, hydroxy amino alkyl (meth)acrylates having 1 to 4 carbon atoms in the alkyl group, and the polymers can contain styrene, alpha methyl styrene, vinyl toluene, (meth)acrylonitrile, (meth)acryl amides, (meth)acrylic acid, (meaning both acrylic acid and methacrylic acid), trimethoxysilylpropyl (meth)acrylate and the like.

Examples of (meth)acrylic acid esters useful for forming these acrylic polymers are methyl acrylate, ethyl acrylate, isopropyl acrylate, tert.-butyl acrylate, n-butyl acrylate, isobutyl acrylate, 2-ethylhexyl acrylate, lauryl acrylate, stearyl acrylate and the corresponding methacrylates. Examples of (meth)acrylic acid esters with cyclic alcohols are cyclohexyl acrylate, trimethylcyclohexyl acrylate, 4-tert.-butylcyclohexyl acrylate, isobornyl acrylate and the corresponding methacrylates.

Additional unsaturated monomers that do not contain additional functional groups useful for forming the acrylic polymers are, for example, vinyl ethers, such as, isobutyl vinyl ether and vinyl esters, such as, vinyl acetate, vinyl propionate, vinyl aromatic hydrocarbons, preferably those with 8 to 9 carbon atoms per molecule. Examples of such monomers are styrene, alpha-methylstyrene, chlorostyrenes, 2,5-dimethylstyrene, pmethoxystyrene, vinyl toluene. Styrene is preferably used.

Small proportions of olefinically polyunsaturated monomers may also be used. These are monomers having at least 2 free-radically polymerizable double bonds per molecule. Examples of these are divinylbenzene, 1,4-butanediol diacrylate, 1,6-hexanediol diacrylate, neopentyl glycol dimethacrylate, glycerol dimethacrylate. Hydroxy-functional (meth)acrylic polymers generally are formed by free-radical copolymerization using conventional processes well known to those skilled in the art, for example, bulk, solution or bead polymerization, in particular by free-radical solution polymerization using free-radical initiators.

Suitable hydroxyl-functional unsaturated monomers that can be used to introduce hydroxyl groups into the acrylic polymer are, for example, hydroxyalkyl esters of alpha, beta-olefinically unsaturated monocarboxylic acids with primary or secondary hydroxyl groups. These may, for example, comprise the hydroxyalkyl esters of acrylic acid, methacrylic acid, crotonic acid and/or isocrotonic acid. The hydroxyalkyl esters of (meth)acrylic acid are preferred. Examples of suitable hydroxyalkyl esters of alpha, beta-olefinically unsaturated monocarboxylic acids with primary hydroxyl groups are hydroxyethyl (meth)acrylate, hydroxypropyl (meth)acrylate, hydroxybutyl (meth)acrylate, hydroxyamyl (meth)acrylate, hydroxyhexyl (meth)acrylate. Examples of suitable hydroxyalkyl esters with secondary hydroxyl groups are 2-hydroxypropyl (meth)acrylate, 2-hydroxybutyl (meth)acrylate, 3-hydroxybutyl (meth)acrylate.

Preferred are hydroxy functional acrylic polymers having a hydroxy equivalent weight of 300 to 1300 and are polymers of hydroxy alkyl (meth)acrylates and one or more of the aforementioned monomers. The hydroxyl equivalent weight is the grams of resin per equivalent of hydroxyl groups. The following are typically preferred acrylic polymers: styrene/methyl methacrylate/isobutyl methacrylate/hydroxyethyl (meth)acrylate; styrene/methyl methacrylate/isobutyl methacrylate/2-ethylhexyl methacrylate/isobornyl methacrylate/hydroxyethyl (meth)acrylate and styrene/isobornyl methacrylate/2-ethylhexyl methacrylate/hydroxy propyl methacrylate/hydroxyethyl (meth)acrylate. One particularly preferred hydroxy containing acrylic polymer contains 35 to 50% by weight styrene, 15 to 25% by weight ethylhexyl methacrylate and 15 to 20% by weight isobornyl methacrylate and 20 to 30% by weight hydroxyethyl methacrylate.

Additional useful hydroxy-functional unsaturated monomers are reaction products of alpha, beta-unsaturated monocarboxylic acids with glycidyl esters of saturated monocarboxylic acids branched in alpha position, for example with glycidyl esters of saturated alpha-alkylalkanemonocarboxylic acids or alpha,alpha'-dialkylalkanemonocarboxylic acids. These preferably comprise the reaction products of (meth)acrylic acid with glycidyl esters of saturated alpha,alpha-dialkylalkanemonocarboxylic acids with 7 to 13 carbon atoms per molecule, particularly preferably with 9 to 11 carbon atoms per molecule. These reaction products may be formed before, during or after the copolymerization reaction.

Further usable hydroxy-functional unsaturated monomers are reaction products of hydroxyalkyl (meth)acrylates with lactones. Hydroxyalkyl (meth)acrylates which may be used are, for example, those stated above. Suitable lactones are, for example, those that have 3 to 15 carbon atoms in the ring, wherein the rings may also comprise different substituents. Preferred lactones are gamma-butyrolactone, delta-valerolactone, epsilon-caprolactone, beta-hydroxy-beta-methyl-delta-valerolactone, lambda-laurolactone or mixtures thereof. Epsilon-caprolactone is particularly preferred. The reaction products preferably comprise those prepared from 1 mole of a hydroxyalkyl ester of an alpha, beta-unsaturated monocarboxylic acid and 1 to 5 moles, preferably on average 2 moles, of a lactone. The hydroxyl groups of the hydroxyalkyl esters may be modified with the lactone before, during or after the copolymerization reaction.

Suitable unsaturated monomers that can be used to provide the acrylic polymer with carboxyl groups are, for example, olefinically unsaturated monocarboxylic acids, such as, for example, acrylic acid, methacrylic acid, crotonic acid, isocrotonic acid, itaconic acid. Acrylic acid and methacrylic acid are preferably used.

Suitable unsaturated monomers that can be used to provide the acrylic polymer with glycidyl groups are, for example, allyl glycidyl ether, 3,4-epoxy-1-vinylcyclohexane, epoxycyclohexyl (meth)acrylate, vinyl glycidyl ether and glycidyl (meth)acrylate. Glycidyl (meth)acrylate is preferably used.

Free-radically polymerizable, olefinically unsaturated monomers which, apart from at least one olefinic double bond, do not contain additional functional groups that can be used to form the acrylic polymer are, for example, esters of unsaturated carboxylic acids with aliphatic monohydric branched or unranked as well as cyclic alcohols with 1 to 20 carbon atoms. The unsaturated carboxylic acids, which may be considered, are acrylic acid, methacrylic acid, crotonic acid and isocrotonic acid. Esters of (meth)acrylic acid are preferred.

The acrylic polymer can contain (meth)acrylamides. Typical examples of such acrylic polymers are polymers of (meth)acrylamide and alkyl (meth)acrylates, hydroxy alkyl (meth)acrylates, (meth)acrylic acid and or one of the aforementioned ethylenically unsaturated polymerizable monomers.

Acrylic oligomers having a number average molecular weight of 300 to 3,000 of the aforementioned monomeric components also can be used as an optional polymeric component in the novel composition. Useful acrylic oligomers are disclosed in U.S. Ser. No. 10/617,585 filed Jul. 11, 2003. By using monomers and reactants well known to those skilled in the art, these oligomers can have the one or more of the following groups that are reactive with isocyanate: hydroxyl, carboxyl, glycidyl, amine, aldimine, phosphoric acid and ketimine.

Acrylourethanes also can be used to form the novel coating composition of this invention. Typical useful acrylourethanes are formed by reacting the aforementioned acrylic polymers with an organic polyisocyanate. Generally, an excess of the acrylic polymer is used so that the resulting acrylourethane has terminal acrylic segments having reactive groups as described above. These acrylourethanes can have reactive end groups and/or pendant groups, such as, hydroxyl, carboxyl, amine, glycidyl, amide, silane or mixtures of such groups. Useful organic polyisocyanates are described hereinafter as the crosslinking component but also can be used to form acrylourethanes useful in this invention. Typically useful acrylourethanes are disclosed in Stamegna et al. U.S. Pat. No. 4,659,780, which is hereby incorporated by reference.

Polyesters can also be used as the binder in the novel coating composition, such as, hydroxyl or carboxyl terminated or hydroxyl or carboxyl containing polyesters. The following are typically useful polyesters or ester oligomers: polyesters or oligomers of caprolactone diol and cyclohexane dimethylol, polyesters or oligomers of tris-hydroxy ethylisocyanurate and caprolactone, polyesters or oligomers of trimethylol propane, phthalic acid or anhydride and ethylene oxide, polyesters or oligomers of pentaerythritol, hexahydrophthalic anhydride and ethylene oxide, polyesters or oligomers of pentaerythritol, hexahydrophthalic anhydride and butylene oxide as disclosed in U.S. Pat. No. 6,221,484 B1.

The aforementioned polyesters and oligomers can be reacted with an organic isocyanate to form polyesterurethane polymers and oligomers that can be used in the novel composition.

One useful polyesterurethane that can used in the novel composition is formed by reacting an aliphatic polyisocyanate with an aliphatic or cycloaliphatic monohydric alcohol and subsequently reacting the resulting composition with a hydroxy functional aliphatic carboxylic acid until all of the isocyanate groups have been reacted. One useful polyurethane oligomer comprises the reaction product of the isocyanurate of hexane diisocyanate, cyclohexanol and dimethylol propionic acid.

Useful branched copolyesters polyols and the preparation thereof are described in WO 03/070843 published Aug. 28, 2003, which is hereby incorporated by reference.

The branched copolyester polyol has a number average molecular weight not exceeding 30,000, alternately in the range of from 1,000 to 30,000, further alternately in the range of 2,000 to 20,000, and still further alternately in the range of 5,000 to 15,000. The copolyester polyol has hydroxyl groups ranging from 5 to 200 per polymer chain, preferably, 6 to 70, and more preferably, 10 to 50, and carboxyl groups ranging from 0 to 40 per chain, preferably, 1 to 40, more preferably 1 to 20 and most preferably, 1 to 10. The Tg (glass transition temperature) of the copolyester polyol ranges from —70° C. to 50° C., preferably from —65° C. to 40° C., and more preferably, from —60° C. to 30° C.

The branched copolyester polyol is conventionally polymerized from a monomer mixture containing a chain extender selected from the group consisting of a hydroxy carboxylic acid, a lactone of a hydroxy carboxylic acid or a combination thereof; and one or more hyper branching monomers.

The following additional ingredients can be included in the coating composition, particularly when the coating composition is useful as a lacquer, in amounts in the range from about 0.1% to 98% by weight and alternately, in the range from about 50% to 95% by weight, all based on the weight of the binder of the coating composition:

Useful acrylic alkyd polymers having a weight average molecular weight ranging from about 3,000 to about 100,000 and a Tg ranging from 0° C. to 100° C. are conventionally polymerized from a monomer mixture that can include one or more of the following monomers: an alkyl (meth)acrylate, for example, methyl (meth)acrylate, butyl (meth)acrylate, ethyl (meth)acrylate, 2-ethyl hexyl (meth)acrylate; a hydroxy alkyl (meth)acrylate, for example, hydroxy ethyl (meth)acrylate, hydroxy propyl (meth)acrylate, hydroxy butyl (meth)acrylate; (meth)acrylic acid; styrene; and alkyl amino alkyl (meth)acrylate, for example, diethylamino ethyl (meth)acrylate or t-butyl aminoethyl methacrylate; and one or more of the following drying oils: vinyl oxazoline drying oil esters of linseed oil fatty acids, tall oil fatty acids or tung oil fatty acids.

One preferred polymer is polymerized from a monomer mixture that contains an alkyl (meth)acrylate, hydroxy alkyl acrylate, alkylamino alkyl acrylate and vinyl oxazoline ester of drying oil fatty acids.

Suitable iminiated acrylic polymers can be obtained by reacting acrylic polymers having carboxyl groups with an alkylene imine, such as, propylene imine.

Suitable cellulose acetate butyrates are supplied by Eastman Chemical Co., Kingsport, Tenn. under the trade names CAB-381-20 and CAB-531-1 and are preferably used in an amount of 0.1 to 20% by weight based on the weight of the binder.

A suitable ethylene-vinyl acetate co-polymer (wax) is supplied by Honeywell Specialty Chemicals —Wax and Additives, Morristown, N.J, under the trade name A-C® 405 (T) Ethylene —Vinyl Acetate Copolymer.

Suitable nitrocellulose resins preferably have a viscosity of about ½-6 seconds. Preferably, a blend of nitrocellulose resins is used. Optionally, the lacquer can contain ester gum and castor oil.

Suitable alkyd resins are the esterification products of a drying oil fatty acid, such as, linseed oil and tall oil fatty acid, dehydrated castor oil, a polyhydric alcohol, a dicarboxylic acid and an aromatic monocarboxylic acid. Typical polyhydric alcohols that can be used to prepare the alkyd resin used in this invention are glycerine, pentaerythritol, trimethylol ethane, trimethylol propane; glycols, such as, ethylene glycol, propylene glycol, butane diol and pentane diol. Typical dicarboxylic acids or anhydrides that can be used to prepare the alkyd resin are phthalic acid, phthalic anhydride, isophthalic acid, terephthalic acid maleic, and fumaric acid. Typical monocarboxylic aromatic acids are benzoic acid, paratertiary butylbenzoic acid, phenol acetic acid and triethyl benzoic acid. One preferred alkyd resin is a reaction product of an acrylic polymer and an alkyd resin.

Suitable plasticizers that can be used include butyl benzyl phthalate, dibutyl phthalate, triphenyl phosphate, 2-ethylhexylbenzyl phthalate, dicyclohexyl phthalate, diallyl toluene phthalate, dibenzyl phthalate, butylcyclohexyl phthalate, mixed benzoic acid and fatty oil acid esters of pentaerythritol, poly(propylene adipate) dibenzoate, diethylene glycol dibenzoate, tetrabutylthiodisuccinate, butyl phthalyl butyl glycolate, acetyltributyl citrate, dibenzyl sebacate, tricresyl phosphate, toluene ethyl sulfonamide, the di-2-ethyl hexyl ester of hexamethylene diphthalate, and di(methyl cyclohexyl) phthalate. One preferred plasticizer of this group is butyl benzyl phthalate.

If desired, the coating composition can include metallic driers, chelating agents, or a combination thereof. Suitable organometallic driers include cobalt naphthenate, copper naphthenate, lead tallate, calcium naphthenate, iron naphthenate, lithium naphthenate, lead naphthenate, nickel octoate, zirconium octoate, cobalt octoate, iron octoate, zinc octoate, and alkyl tin dilaurates, such as dibutyl tin dilaurate. Suitable chelating agents include aluminum monoisopropoxide monoversatate, aluminum (monoiospropyl)phthalate, aluminum diethoxyethoxide monoversatate, aluminum trisecondary butoxide, aluminum diisopropoxide monoacetacetic ester chelate and aluminum isopropoxide.

Also, polytrimethylene ether diols may be used as an additive having a number average molecular weight (Mn) in the range of from 500 to 5,000, alternately, in the range of from 1,000 to 3,000; a polydispersity in the range of from 1.1 to 2.1 and a hydroxyl number in the range of from 20 to 200. The preferred polytrimethylene ether diol has a Tg of —75° C. Copolymers of polytrimethylene ether diols are also suitable. For example, such copolymers are prepared by copolymerizing 1,3-propanediol with another diol, such as, ethane diol, hexane diol, 2-methyl-1,3-propanediol, 2,2-dimethyl-1,3-propanediol, trimethylol propane and pentaerythritol, wherein at least 50% of the copolymer results from 1,3-propanediol. A blend of a high and low molecular weight polytrimethylene ether diol can be used wherein the high molecular weight diol has an Mn ranging from 1,000 to 4,000 and the low molecular weight diol has an Mn ranging from 150 to 500. The average Mn of the diol should be in the range of 1,000 to 4,000. It should be noted that, the polytrimethylene ether diols suitable for use in the present invention can include polytrimethylene ether triols and other higher functionality polytrimethylene ether polyols in an amount ranging from 1 to 20%, by weight, based on the weight of the polytrimethylene ether diol. It is believed that the presence of polytrimethylene ether diols in the crosslinked coating composition of this invention can improve the chip resistance of a coating resulting therefrom.

Additional details of the foregoing additives are provided in U.S. Pat. Nos. 3,585,160, 4,242,243, 4,692,481, and U.S. Re 31,309, which are incorporated therein by reference.

Crosslinking Agents

Lacquer coating compositions can be formulated without the use of a crosslinking agent. However, many coating compositions currently contain crosslinking agents to provide fast curing and durable finishes. Typical crosslinkable coating compositions have a binder content in the range from about 25-95 percent by weight of one of the aforementioned film forming polymers and in the range from about 5-75 percent by weight of a crosslinking agent. Preferably, the binder contains in the range from about 40-90 percent by weight of the film forming polymer and in the range from about 10-60 percent by weight of the crosslinking agent. Useful crosslinking agents include, organic polyisocyanates, blocked organic polyisocyanates, melamines, alkylated melamines, benzoquanamines, epoxides, silanes, ketimines, polyamines, polyacids and any mixtures of these crosslinking agents.

Typically useful organic polyisocyanates crosslinking agents that can be used in the novel composition of this invention include aliphatic polyisocyanates, cycloaliphatic polyisocyanates and isocyanate adducts. Typical polyisocyanates can contain within the range from about 2 to 10, preferably, 2.5 to 8, more preferably, 3 to 5 isocyanate functionalities. Generally, the ratio of equivalents of isocyanate functionalities on the polyisocyanate per equivalent of all of the functional groups present ranges from about 0.5/1 to 3.0/1, preferably, from about 0.7/1 to 1.8/1, more preferably, from about 0.8/1 to 1.3/1.

Examples of suitable aliphatic and cycloaliphatic polyisocyanates that can be used include the following: 4,4′dicyclohexyl methane diisocyanate, (“H₁₂MDI”), trans-cyclohexane-1,4-diisocyanate, 1,6-hexamethylene diisocyanate (“HDI”), isophorone diisocyanate,(“IPDI”), other aliphatic or cycloaliphatic di-, tri- or tetra-isocyanates, such as, 1,2-propylene diisocyanate, tetramethylene diisocyanate, 2,3-butylene diisocyanate, octamethylene diisocyanate, 2,2,4-trimethyl hexamethylene diisocyanate, dodecamethylene diisocyanate, omega-dipropyl ether diisocyanate, 1,3-cyclopentane diisocyanate, 1,2 cyclohexane diisocyanate, 1,4 cyclohexane diisocyanate, 4-methyl-1,3-diisocyanatocyclohexane, dicyclohexylmethane-4,4′-diisocyanate, 3,3′-dimethyl-dicyclohexylmethane 4,4′-diisocyanate, polyisocyanates having isocyanurate structural units, such as, the isocyanurate of hexamethylene diisocyanate and the isocyanurate of isophorone diisocyanate, the adduct of 2 molecules of a diisocyanate, such as, hexamethylene diisocyanate, uretidiones of hexamethylene diisocyanate, uretidiones of isophorone diisocyanate and a diol, such as, ethylene glycol, the adduct of 3 molecules of hexamethylene diisocyanate and 1 molecule of water, allophanates, trimers and biurets of hexamethylene diisocyanate, allophanates, trimers and biurets of isophorone diisocyanate and the isocyanurate of hexane diisocyanate.

Tri-functional isocyanates also can be used, such as, Desmodur® N 3300, trimer of hexamethylene diisocyanate, Desmodur® 3400, trimer of isophorone diisocyanate, Desmodur® 4470 trimer of isophorone diisocyanate, these trimers are sold by Bayer Corporation. A trimer of hexamethylene diisocyanate sold as Tolonate® HDT from Rhodia Corporation is also suitable.

An isocyanate functional adduct can be used, such as, an adduct of an aliphatic polyisocyanate and a polyol. Also, any of the aforementioned polyisocyanates can be used with a polyol to form an adduct. Polyols, such as, trimethylol alkanes, particularly, trimethylol propane or ethane can be used to form an adduct.

The melamine crosslinking agents are generally partially alkylated melamine formaldehyde compounds and may be monomeric or polymeric or mixtures thereof. Some of the suitable monomeric melamines include low molecular weight melamines which contain, on an average, three or more methylol groups etherized with a C₁ to C₅ monohydric alcohol, such as, methanol, n-butanol, or isobutanol per triazine nucleus, and have an average degree of condensation up to about 2 and preferably in the range of about 1.1 to about 1.8, and have a proportion of mononuclear species not less than about 50 percent by weight. By contrast, the polymeric melamines have an average degree of condensation of more than 1.9. Some such suitable monomeric melamines include alkylated melamines, such as, methylated, butylated, isobutylated melamines and mixtures thereof. Many of these suitable monomeric melamines are supplied commercially. For example, Cytec Surface Specialties Inc., Smyrna, Ga., hereinafter, Cytec, supplies Cymel® 301 (degree of polymerization of 1.5, 95% methyl and 5% methylol), Cymel® 350 (degree of polymerization of 1.6,84% methyl and 16% methylol), 303, 325, 327 and 370, which are all monomeric melamines. Suitable polymeric melamines include high amino (partially alkylated) melamine known as Resimene® BMP5503 (molecular weight 690, polydispersity of 1.98, 56% butyl, 44% amino), which is supplied by Surface Specialties Melamines, Inc. Philadelphia, Pa. or Cymel®1158 provided by Cytec. Cytec also supplies Cymel® 1130@80 percent solids (degree of polymerization of 2.5), Cymel® 1133 (48% methyl, 4% methylol and 48% butyl), both of which are polymeric melamines.

If desired, appropriate catalysts may also be included in the activated compositions to accelerate the curing process of a potmix of the coating composition.

When the activated compositions include melamine as the crosslinking agent, it also preferably includes a catalytically active amount of one or more acid catalysts to further enhance the crosslinking of the components on curing. Generally, catalytically active amount of the acid catalyst in the coating composition ranges from about 0.1 percent to about 5 percent, preferably, ranges from 0.1 percent to 2 percent and more preferably, ranges from 0.5 percent to 1.2 percent, all in weight percent based on the weight of the binder. Some suitable acid catalysts include aromatic sulfonic acids, such as, dodecylbenzene sulfonic acid, para-toluenesulfonic acid and dinonylnaphthalene sulfonic acid, all of which are either unblocked or blocked with an amine, such as, dimethyl oxazolidine and 2-amino-2-methyl-1 -propanol, n,n-dimethylethanolamine or a combination thereof. Other acid catalysts that can be used, such as, phosphoric acids, more particularly, phenyl acid phosphate, benzoic acid, oligomers having pendant acid groups, all of which may be unblocked or blocked with an amine.

When the activated compositions include a polyisocyanate as the crosslinking agent, the coating composition preferably includes a catalytically active amount of one or more tin or tertiary amine catalysts for accelerating the curing process. Generally, catalytically active amount of the catalyst in the coating composition ranges from about 0.001 percent to about 5 percent, preferably, ranges from 0.005 percent to 2 percent and more preferably, ranges from 0.01 percent to 1 percent, all in weight percent based on the weight of the binder. A wide variety of catalysts can be used, such as, tin compounds, including dibutyl tin dilaurate and dibutyl tin diacetate; tertiary amines, such as, triethylenediamine. These catalysts can be used alone or in conjunction with carboxylic acids, such as, acetic acid. One of the commercially available catalysts, sold under the trademark, Fastcat® 4202 dibutyl tin dilaurate by Elf-Atochem North America, Inc. Philadelphia, Pa., is particularly suitable.

Liquid Carrier Medium

The liquid carrier for the novel composition can be an organic solvent, a mixture of organic solvents, a mixture of organic solvents and non-solvents, an aqueous medium, and aqueous medium containing one or more organic solvents. The coating compositions contain in the range from about 5-95 percent, more typically, in the range from about 10-85 percent by weight of a liquid carrier (based on the weight of the coating composition).

If an organic solvent or blend of organic solvent and organic non-solvent is used, the selection of organic solvent or non-solvent depends upon the requirements of the specific end use application of the coating composition of this invention, such as, the VOC (volatile organic content) emission requirements, the selected pigments, binder and crosslinking agents. Representative examples of organic solvents which are useful herein include alcohols, such as, methanol, ethanol, n-propanol, and isopropanol; ketones, such as, acetone, butanone, pentanone, hexanone, and methyl ethyl ketone, methyl isobutyl ketone, diisobutyl ketone, methyl amyl ketone; alkyl esters of acetic, propionic, and butyric acids, such as, ethyl acetate, butyl acetate, and amyl acetate; ethers, such as, tetrahydrofuran, diethyl ether, and ethylene glycol and polyethylene glycol monoalkyl and dialkyl ethers, such as, cellosolves and carbitols; and glycols, such as, ethylene glycol and propylene glycol and mixtures thereof, and aromatic hydrocarbon solvents, such as, xylene, toluene.

Pigments

The coating composition contains pigments, which may be the TIO₂ Pigments by themselves or in a mixture with other pigments, particularly colored pigments or filler pigments. Typically, useful coating compositions that contain pigments are base coats of a clear/ coat base coat coated substrate conventionally used on automobiles and trucks or pigmented mono-coat topcoats, primers, primer surfacers, sealers and electrocoating compositions. These compositions require the presence of pigments, typically in a pigment-to-binder ratio in the range from about 0.1/100 to about 300/100 depending on the color and type of pigment used. The pigments including the TIO₂ Pigments are formulated into mill bases or toners by conventional procedures, such as, grinding, sand milling, ball milling, high speed mixing, attritor grinding and two or three roll milling. Generally, the mill base comprises pigment and a dispersant in a liquid carrier. The mill base is added in an appropriate amount to the coating composition with mixing to form a pigmented coating composition.

In addition to the TIO₂ Pigments any of the conventionally-used organic and inorganic pigments, such as, color pigments, metallic flakes, such as, aluminum flake, special effects pigments, such as, coated mica flakes, coated aluminum flakes and the like, azo, anthraquinone, thioindigo, oxazine, quinacridone, lakes and toners of acidic dye stuffs, copper phthalocyanine and its derivatives, and various mixtures and modifications thereof and extender pigments can be used.

The novel coating composition may be used as a primer, primer surfacer or sealer in which case typical pigments used in primers would be added along with the TIO₂ Pigments, such as, carbon black, barytes, silica, iron oxide and other pigments that are commonly used usually in a pigment-to-binder ratio of 10/100 to 300/100.

Other Additives

To improve the weathering properties, the coating composition can contain about 0.1 to 5% by weight, based on the weight of the binder, of ultraviolet light absorbers or antioxidants or hindered amine light stabilizers or any mixtures of the above as are known to those skilled in the art.

In addition, the novel coating composition may also contain a variety of other optional compatible ingredients, including fillers, plasticizers, antioxidants, surfactants and flow control agents. For example, such coating compositions may contain 0.1 to 30% by weight, based on the weight of the binder, of acrylic NAD (non-aqueous dispersed) resins. These NAD resins typically are high molecular weight resins having a crosslinked acrylic core with a Tg between 20° C. to 100° C. and attached to the core are low Tg stabilizer segments. A description of such NADs is found in Antonelli et al. U.S. Pat. No. 4,591,533 and in Barsotti et al. U.S. Pat. No. 5,763,528 which patents are hereby incorporated by reference.

Also, such coating compositions may include other conventional formulation additives known to those skilled in the art, such as, wetting agents, leveling and flow control agents, for example, Resiflow® S (polybutylacrylate), BYK® 320 and 325 (high molecular weight polyacrylates), BYK® 347 (polyether-modified siloxane), rheology control agents, such as, fumed silica, defoamers, surfactants and emulsifiers to help stabilize the composition. Other additives that tend to improve mar resistance can be added, such as, silsesquioxanes and other silicate-based micro-particles.

Tints

The TIO₂ Pigments are useful in formulating tints that are used to make a variety of colored coating compositions. In the formulation of a typical coating composition, a formula is provided wherein tints of various colors are blended together to formulate the coating composition.

Tints typically contain pigments, a liquid carrier medium, such as an organic solvent or mixtures of solvents or an aqueous medium and a dispersant, which may be a polymeric dispersant or may be anyone of the aforementioned binders used to formulate coating compositions. Tints generally have a solids content of 20 to 80 percent by weight and a corresponding liquid carrier content of 80 to 20 percent by weight. Typically, the solids content comprises 2 to 70 percent by weight pigment, 0 to 20 percent by weight of a dispersant.

Any of the aforementioned pigments can be used to form the tint in combination with the TIO₂ Pigments. It is well know to one skilled in the art, that not all tints will contain the TIO₂ Pigments. However, tint colors containing TIO₂ Pigment will provide the desired shade of color. The advantages of the TIO₂ Pigments are that they are readily dispersed and therefore, lesser amounts of these pigments are required since the dispersion of these pigments is highly efficient and less if any agglomeration of pigments occurs. Further, tints formulated with these TIO₂ Pigments have an extended shelf life of two years and more since the pigments remain in dispersion and do not tend to settle out or separate from the tint.

Typically useful pigment dispersants that can be used to form the tints are shown in Ma U.S. Pat. No. 6,472,463 (Example 6), which is hereby incorporated by reference.

Application

The coating composition can be applied by conventional techniques, such as, spraying, electrostatic spraying, dipping, brushing, and flow coating. Spraying and electrostatic spraying are preferred methods of application.

If the novel coating composition containing the TIO₂ Pigments is used as a pigmented base coat, a clear coating is applied over the base coat. The clear coating can be in solution or in dispersion form.

Typically, a clear coating is applied over the base coating before the base coating is fully cured. This is a so-called “wet-on-wet process”. In this process, a base coating is applied to a substrate and flash dried and then the clear coating is applied and both layers are then fully cured either at ambient temperatures or cured by heating to elevated temperatures, for example, of 50° C. to 100° C. for 15 to 45 minutes to form a clear coat/base coat finish. When used in combination with a primer or primer-surfacer which may contain the TiO₂ Pigments, the primer or primer-surfacer is also flash dried and then the base coating and clear coating are applied as above. This is a so-called “wet on wet on wet” process. The base coating and clear coating preferably have a dry coating thickness ranging from 25 to 75 microns and 25 to 100 microns, respectively.

The novel coating composition exhibits a particular advantage when applied at relatively high temperatures and high humidity process conditions in comparison to the same coating composition formulated with conventional prior art titanium dioxide pigments. When the novel composition is applied at 27° C. and above, e.g., up to 50° C., and under high relative humidity conditions of 85% R.H. and above, e.g., up to 100% R.H., the resulting coating has a wave scan R value of at least 6.3 and preferably, 8.0-9.8. These wave scan values are significantly higher than the same composition formulated with conventional titanium dioxide pigments and the novel composition also has improved haze and gloss retention in comparison to the conventional coating compositions.

When refinishing automobile and truck bodies, the original OEM topcoat is usually sanded and a primer or sealer coat applied and then a mono coat or a basecoat/clear coat is applied. These coatings are usually cured at ambient temperatures or at slightly elevated temperatures, such as, 40° C. to 100° C.

In OEM applications, the composition is typically baked at 60° C. to 150° C. for about 15-30 minutes to form a coating about 25 to 75 microns thick. When the composition is used in a basecoat/clearcoat system, the basecoat may be dried to a tack-free state and cured or preferably flash dried for a short period before the clearcoat is applied (wet-on-wet). The basecoat/clearcoat finish is then baked as mentioned above to provide a dried and cured finish. The novel coating composition can also be formulated with the 3-wet (wet-on-wet-on-wet) coating process, where the primer, basecoat and clearcoat are applied to a substrate in sequential steps without baking process in between each layer. The final three layer coated substrate coating is then baked to provide a dried and cure finish.

The coating composition is particularly useful for the repairing and refinishing of automobile bodies and truck bodies and parts, as a pigmented mono coat, pigmented base coat, sealer, primer surfacer or primer filler. The novel composition has uses for coating any and all items manufactured and painted by automobile sub-suppliers, frame rails, commercial trucks and truck bodies, including but not limited to beverage bottles, utility bodies, ready mix concrete delivery vehicle bodies, waste hauling vehicle bodies, and fire and emergency vehicle bodies, as well as any potential attachments or components to such truck bodies, buses, farm and construction equipment, truck caps and covers, commercial trailers, consumer trailers, recreational vehicles, including but not limited to, motor homes, campers, conversion vans, vans, large commercial aircraft and small pleasure aircraft, pleasure vehicles, such as, snow mobiles, all terrain vehicles, personal watercraft, motorcycles, and boats. The novel composition also can be used as a coating for industrial and commercial new construction and maintenance thereof; cement and wood floors; walls of commercial and residential structures, such as, office buildings and homes; amusement park equipment; concrete surfaces, such as parking lots and drive ways; asphalt and concrete road surface, wood substrates, marine surfaces; outdoor structures, such as bridges, towers; coil coating; railroad cars; printed circuit boards; machinery; OEM tools; signs; fiberglass structures; sporting goods; and sporting equipment.

The present invention is further defined in the following Examples. It should be understood that these Examples are given by way of illustration only. From the above discussion and these Examples, one skilled in the art can ascertain the essential characteristics of this invention, and without departing from the spirit and scope thereof, can make various changes and modifications of the invention to adapt it to various uses and conditions. As a result, the present invention is not limited by the illustrative examples set forth herein below, but rather is defined by the claims contained herein below

The following test methods used in the Examples.

“Wave scan” is determined with a using a Byk WaveScan Plus instrument Model 4812 manufactured by Byk Gardner Corporation located Columbia, Md., USA which measures surface structure characteristics at varying spatial wavelengths, i.e., long and short wave lengths and an R value.

Gloss and Haze measurements—gloss and haze were measured at 20 and 60 degrees using a Byk Gardner Gloss and Haze Meter.

Distinctness of Image (DOI) —was measured using a Dogrin II (Hunter Lab, Reston Va.)

Gloss Retention—the level of gloss retained after a finish of a coating composition has been applied under high humidity and temperature conditions, 27° C. (80° F.) at 85% relative humidity and exposed to various conditions for a period of time. Gloss retention should be at least 90%.

The following Examples illustrate the invention. All parts and percentages are on a weight basis unless otherwise indicated. All molecular weights disclosed herein are determined by LC/MS (Liquid Chromatography/Mass Spectroscopy) and/or GPC (gel permeation chromatography) using a polystyrene standard.

### EXAMPLES

### Example 1

### Preparation of Dispersion/Tint using Commercial Titanium Dioxide Pigments and TiO₂ Piqments

A slurry was prepared by blending together the following ingredients in the order given:

| | PowerTint | Experimental |
|---|---|---|
| | PT101 | Tint |
| Ingredients | Slurry | Slurry |
| Butyl Acetate | 16.4 | 16.4 |
| Quaternary dispersant (Prepared according | 3.8 | 3.8 |
| to Example 6 of U.S. Pat. No. 6,472,463 | | |
| except that methyl toluene sulfonate was used | | |
| instead of benzyl chloride.) | | |
| RCP29406¹ (grind resin solution of a random | 14.1 | 14.1 |
| acrylic polymer of | | |
| Sty/IBOMA/EHA/HEMA/BMA/MMA in an | | |
| organic solvent.) | | |
| Bentone 27² (bentonite clay) | 0.65 | 0.65 |
| Ti-Pure TiO2, R-960¹ (conventional | 65 | — |
| commercial titanium dioxide pigments) | | |
| Ti-Pure TiO2, TS-6200¹ (TiO₂ Pigments | — | 65 |
| prepared according to the process of U.S. | | |
| Pat. No. 6,783,586) | | |

Note:
all amounts parts by weight percent of the total.
Sty—styrene,
IBOMA—isobornyl methacrylate,
EHA—2-ethyl hexyl acrylate,
HEMA—2-hydroxy ethyl methacrylate,
BMA—butyl methacrylate,
MMA—methyl methacrylate
Sources of the above constituents are as follows:
¹Product of E. I. DuPont de Nemours and Company
²Product of Elementis Company

Each of the above slurries was then ground using a sandmill dispersion process using a dispersion to media load of 40:60 by volume. The media used was 0.8 mm glass media and this slurry was ground for two passes to form a dispersion. Once complete, each dispersion was let down to form a tint by blending together the following ingredients in the following order given:

| | PowerTint | Experimental |
|---|---|---|
| Ingredients | PT101 | Tint |
| PowerTint PT101 Dispersion (prepared above) | 93.67 | — |
| Experimental Tint Dispersion (prepared above) | — | 93.67 |
| RCP29937¹ (tint resin solution of a random | 4.75 | 4.75 |
| acrylic polymer of | | |
| Sty/IBOMA/EHA/HEMA/HPMA | | |
| in methyl ethyl ketone) | | |
| Butyl Acetate | 1.58 | 1.58 |

Note:
all amounts parts by weight percent of the total)
HPMA—hydroxy propyl methacrylate
Sources of the above constituents are as follows:
¹Product of E. I. DuPont de Nemours and Company

### Preparation of Comparative Example 1 and Example 2.

White single-stage coatings using Power Tint PT 101 (conventional tint) and the improved TiO₂ Pigment tint (Experimental Tint) were prepared by blending together the following ingredients in the order given:

| | Comp. | |
|---|---|---|
| Ingredients | Ex. 1 | Ex. 2 |
| Hydroxylated Polyester Resin I¹ | 7.435 | 7.435 |
| Methyl Amyl Ketone | 4.325 | 4.325 |
| Dibasic Ester DBE² - dibasic acid ester solvent | 1.104 | 1.104 |
| 2-Ethyl Hexyl Acetate | 6.000 | 6.000 |
| Tinuvin ® 328³ - Benzotriazole UV Light Absorber | 0.855 | 0.855 |
| Tinuvin ® 292³ - Hindered Amine UV Light | 0.855 | 0.855 |
| Absorber | | |
| Zonyl ® FSO 100¹ - Fluorosurfactant Solution | 0.007 | 0.007 |
| Resiflow ® S⁴ - Flow Control Agent | 0.056 | 0.056 |
| Zoldine ® MS-Plus⁵ - Moisture Scavenger | 0.741 | 0.741 |
| Power ® Tint PT101¹ - White Tint (prepared | 62.550 | — |
| above | | |
| Experimental Tint - White Tint (prepared above) | — | 62.550 |
| MasterTint HS ® Tint 501H¹ - Black Tint | 1.696 | 1.696 |
| MasterTint HS ® Tint 538H¹ - Yellow Tint | 0.169 | 0.169 |
| Hydroxylated Acrylic Resin II¹ | 5.710 | 5.710 |
| Hydroxylated Polyester Resin I¹ | 8.497 | 8.497 |
| Total | 100.000 | 100.000 |

Note:
all amounts parts by weight percent of the total)
Hydroxylated Polyester Resin I - resin of methyl hexahydrophthalic anhydride/pentaerythritol/glycidyl ester of t-carboxylic acid.
Hydroxylated Acrylic Resin II - resin of styrene/isobornyl methacrylate/hydroxypropyl acrylate/ethyhexyl acrylate/isobutyl methacrylate.
Hydroxylated Polyester Resin II - resin of trimethylol propane/methyl hexahydrophthalic anhydride/ethylene oxide.
Sources of the above constituents are as follows:
¹Product of E. I. DuPont de Nemours and Company
²Product of Invista Company
³Product of Ciba Speciality Chemical Company
⁴Product of Estron Chemical Company
⁵Product of Angus Chemical Company

The above prepared white single-stage comparative Example 1 and Example 2 (invention) were then mixed with the following ingredients before spray application:

Ingredients
(all amounts by volume of the total)

| | |
|---|---|
| Example 1 or 2 | 2.00 Parts |
| Desmodur ® N-3300⁶ Polyisocyanate (aliphatic | 1.00 Parts |
| polyisocyanate resin in blend of acetate solvents) | |
| Imron ® 3000 Medium Potlife¹ Extender (blend of | 0.25 parts |
| solvents of butyl acetate, 2,4 pentanedione, | |
| methyl n-propyl ketone, methyl isobutyl ketone) | |
| 2165S Fast Reducer¹ [blend of acetone and | 0.75 Parts |
| benzene,1-chloro-4 (trifluoromethyl)] | |

Sources of the above constituents are:
¹Product of E. I. DuPont de Nemours and Compnany
⁶Product of Bayer Polymers LLC

Aluminum panels that had been primed with a white epoxy primer sealer and then sanded (240 grit), were sprayed and coated respectively with each of the above prepared Comparative Example 1 and Example 2 (invention) formulations to form a layer 2.0-2.5 mil thick (50-62.5 microns). The panels were then fully cured by baking 2 hours at about 120° F. (49° C.). The resulting coated panels were measured for the below properties, and the results are shown in the following Table 1.

The following properties of the above coated panels were measured: 20° Gloss, Distinctness of Image (DOI), Haze, and Wavescan.

TABLE 1

| | Comparative | Example 2 |
|---|---|---|
| Property | Example 1 | (invention) |
| 20° Gloss | 89.8 | 90.3 |
| DOI | 85.2 | 90.2 |
| Haze | 41.0 | 30.9 |
| Wavescan Long | 35.3 | 11.4 |
| Wavescan Short | 24.8 | 8.0 |
| Wavescan R Value | 3.6 | 6.3 |

The above data shows that the coating composition (Example 2 —the invention) has improved DOI, Haze and Wavescan values versus the commercial TiO₂ composition of Example 1.

### Comparative Example 3 and Example 4 (Invention)

White single-stage coatings of Examples 3 and 4 were prepared by blending together the following ingredients in the order given:

| Ingredients | Ex. 3 | Ex. 4 |
|---|---|---|
| Imron ® Elite Single Stage Binder¹ - 21-36% of a | 12 | 12 |
| polyester and acrylic resin mixture, 5-15% | | |
| amorphous silica, 27-37% methyl amyl ketone, | | |
| 5-15% isopropanol and 5-15% butyl acetate. | | |
| Imron ® Elite Binder¹ - 27-37% acrylic polymer, | 10.6 | 10.6 |
| 38-48% polyester resin, 5-15% ethyl acetate, 1-4% | | |
| heptane, 16-26% methyl amyl ketone, | | |
| 1-4% aromatic hydrocarbon solvent. | | |
| Imron ® Elite Balancer¹ - 72-81% polyester resin, | 12.98 | 12.98 |
| 1-4% heptane, 5-15% ethyl acetate, | | |
| 1-4% aromatic hydrocarbon solvent. | | |
| Power ® Tint PT181¹ - Yellow Oxide Tint | 0.074 | 0.074 |
| (acrylic polymer, butyl acetate, iron oxide yellow | | |
| pigment methyl amyl ketone and dispersant) | | |
| Power ® Tint PT133¹ - Blue Shade Green LS Tint | 0.224 | 0.224 |
| (acrylic polymer, butyl acetate, methyl amyl ketone | | |
| copper phthalocyanine green pigment) | | |
| Power ® Tint PT107¹ - Black LS Tint (acrylic | 1.596 | 1.596 |
| polymer, butyl acetate, carbon black, 0.5%, | | |
| methyl amyl ketone) | | |
| Power ® Tint PT101 - White Tint (prepared in | 47.823 | — |
| Example 1) | | |
| Experimental Tint (prepared in Example 1) | — | 47.823 |
| Power ® Tint PT195¹ - Additive for Solids | 2.13 | 2.13 |
| (piperidinyl sebacate, decanedoic acid, piperidinyl | | |
| ester, methyl amyl ketone, methyl pyrrolidone | | |
| and triethylenediamine.) | | |
| Reducer for Single Stage¹ (acetone, ethyl | 12.567 | 12.567 |
| acetate, ketone solvent and 2 ethyl hexyl acetate) | | |
| Total | 100.000 | 100.000 |

Note:
all amounts parts by weight percent of the total)
Sources of the above constituents are as follows:
¹Product of E. I. DuPont de Nemours and Company

The following properties of the above coatings were

measured:

TABLE 2

| | Example 3 | Example 4 |
|---|---|---|
| Property | (comparative) | (invention) |
| Brookfield Viscosity, 1 rpm, cps | 600 | 670 |
| Brookfield Viscosity, 20 rpm, cps | 272 | 160 |
| Brookfield Viscosity, 50 rpm, cps | 191 | 125 |
| Zahn #3 cup, sec (unactivated) | 14.3 | 11.9 |
| Pot life at 0 min, Zahn #3 cup, sec | 13.2 | 11.6 |
| Pot life at 60 min, Zahn #3 cup, sec | 18.7 | 15.4 |
| Pot life at 120 min, Zahn #3 cup, sec | 24.7 | 18 |

The above data shows that the coating composition of the invention, Example 4, has improved rheology properties and potlife versus the composition in Example 3, which represents a commercial composition.

The above prepared white single-stage Examples 3 and 4 were then mixed with the following ingredients before spray application:

Ingredients
(all amounts by volume of the total)

| | |
|---|---|
| Example 3 or 4 | 3.00 Parts |
| Desmodur ® N-3300 Polyisocyanate | 1.00 Part |
| (described in Example 1) | |

Bare aluminum panels were sprayed at 80° F. (27° C.) and 85% humidity and coated respectively with each of the above Example 3 and 4 formulations to form a layer 2.0-2.5 mil thick (50-62.5 microns). The panels were then fully cured by baking 30 minutes at about 180° F. (77° C.). The resulting coated panels were measured for 20°and 60° Gloss, Distinctness of Image (DOI), and Wavescan and the results are tabulated in Table 3.

TABLE 3

| | Example 3 | Example 4 |
|---|---|---|
| Property | Comparative | Invention |
| 20° Gloss | 82 | 83.4 |
| 60° Gloss | 93 | 93.7 |
| DOI | 90.7 | 92.7 |
| Wavescan Long | 7.7 | 3 |
| Wavescan Short | 5.5 | 4.1 |
| Wavescan R Value | 7.5 | 9.4 |

The above data shows that the coating composition of the invention (Example 4) has improved gloss, DOI, and Wavescan values versus the composition of Example 3, which represent a commercial composition, when spray at high temperature and high humidity conditions.

The above prepared white single-stage Examples 3 and 4 were then mixed with the following ingredients before spray application:

Ingredients
(all amounts by volume of the total)

| | |
|---|---|
| Example 3 or 4 | 3.00 Parts |
| Desmodur ® N-3300 Polyisocyanate | 1.00 Parts |
| (described in Example 1) | |

Pre-primed electrocoated panels were sprayed and coated respectively with each of the above example formulations to form a layer 2.0-2.5 mil thick (50-62.5 microns). The panels were then fully cured by baking 30 minutes at about 180° F. (77° C.). The resulting coated panels were exposed to WOM QUV-313 accelerated weathering and panel sent to Florida for exposure. The returned panels were then measured for 20° and 60° Gloss Retention, Distinctness of Image (DOI) Retention, and color shift, delta E and the results are tabulated in Table 4.

TABLE 4

| Property | Example 3 | Example 4 |
|---|---|---|
| 20° Gloss Retention @ 1000 hours | 87 | 99 |
| 60° Gloss Retention @ 1000 hours | 100 | 100 |
| DOI Retention @ 1000 hours | 87 | 100 |
| Delta E @ 1000 hours | 1.61 | 0.34 |
| 20° Gloss Retention @ 3000 hours | 21 | 32 |
| 60° Gloss Retention @ 3000 hours | 65 | 79 |
| DOI Retention @ 3000 hours | 76 | 89 |
| Delta E @ 3000 hours | 0.83 | 0.19 |
| 20° Gloss Retention @ 6 months Florida | 82 | 97 |
| 60° Gloss Retention @ 6 months Florida | 93 | 100 |
| DOI Retention @ 6 months Florida | 99 | 100 |
| Delta E @ 6 months Florida | 1.4 | 1.2 |

The above data shows that the coating composition (Example 4, the invention) has improved gloss, DOI, and color retention values versus the composition in Example 3, which represents a commercial composition, when coated panel were exposed to accelerated weathering and other panel exposed to Florida exposure conditions.

1. A coating composition comprising a film forming binder and coated titanium dioxide pigment in a pigment to binder weight ratio in the range of from about 0.1:100 to about 300:100;
wherein the TiO₂ Pigments comprise titanium dioxide first coated with silica in the presence of citric acid and having a second coating of alumina;
whereby a cured finish resulting from the coating composition over a substrate has a wave scan R value of at least 6.3 when the coating composition is applied at 27° C. and 85% relative humidity.

2. The coating composition of claim 1 wherein the coated titanium dioxide pigment has a coating of about 3 weight % to about 6 weight %, based on the weight of titanium dioxide pigment before it is coated, of silica and about 1 weight % to about 4 weight %, based on the weight of titanium dioxide pigment before it is coated, of amorphous alumina.

3. The coating composition of claim 2 wherein the coating composition contains coated titanium dioxide pigment in a pigment to binder weight ratio of about 1:100 to about 200:100.

4. The coating composition of claim 3 having a wave scan R value in the range of 8.0 -9.8.

5. The coating composition of claim 2 wherein the binder is selected from the group consisting of poly(meth)acrylates, branched, grafted or segmented poly(meth)acrylates, acrylic alkyd resins, polyesters, branched polyesters, oligomers, polyesterurethanes, acrylic polyurethanes, acrylic polyesters, polyurethanes, alkyd resins, alkyd acrylic resins, epoxy resins, epoxy esters resins, epoxy acrylic resins, acrylamides, methacrylamides, nitrocellulose, cellulose acetate butyrate, ethylene/vinyl acetate polymers and any mixtures thereof.

6. The coating composition of claim 2 wherein the binder is selected from the group consisting of poly(meth)acrylates, branched, grafted or segmented poly(meth)acrylates, polyacrylourethanes, polyesters, branched copolyesters, oligomers, polyester urethanes and polyepoxides and wherein the binder contains reactive moieties selected from the group consisting of hydroxyl, carboxyl, anhydride, glycidyl, primary amino groups, secondary amino groups, acetoacetoxy moieties and ketimine moieties.

7. The coating composition of claim 6 containing a crosslinking agent suitable for reacting with the reactive moieties of the binder and crosslinking the binder selected from the group consisting of polyisocyanates, blocked polyisocyanates, melamine crosslinking agents, alkylated melamines, silanes, benzoguanamines, epoxides, ketimines, polyamines and polyacids.

8. The coating composition of claim 7 which is a waterborne composition.

9. The coating composition of claim 7 which is a solventborne composition.

10. The coating composition of claim 7 which is a powder coating composition.

11. A tint composition comprising a liquid medium, a dispersant, coated titanium dioxide pigment that comprises titanium dioxide first coated with silica in the presence of citric acid and having a second coating of alumina;
whereby the tint has improved shelf life of at least 2 years.

12. A coating composition comprising a film forming binder and the tint composition of claim 11.

13. A substrate coated with the coating composition of claim 1.

14. A substrate coated with a layer of the coating composition of claim 1 as a base coat and having a layer of a clear coating composition thereover.

15. A substrate coated with the composition of claim 1 wherein the composition is a primer or primer surfacer.

16. A substrate coated with the composition of claim 1 wherein the composition is a pigmented mono-coat layer.

17. A process for coating substrates which comprises
applying a layer of a coating composition under relatively high temperature and humidity conditions to a substrate and curing the coating composition to form a cured finish;
wherein the a coating composition comprising a film forming binder and TiO₂ Pigments in a pigment to binder weight ratio in the range of from about 0.1:100 to about 300:100 and the TiO₂ Pigments comprise titanium dioxide first coated with silica in the presence of citric acid and having a second coating of alumina; and
whereby the cured finish has a wave scan R value of at least 6.3 and has reduced haze and improved gloss retention.

18. The process of claim 17 wherein the coating composition is applied at about 27° C. to 50° C. and at 85% to 100% relative humidity and whereby the resulting cured finish has a wave scan R value of 8 to 9.8.

19. The process of claim 18 wherein the coated titanium dioxide pigment of the coating composition has a coating of about 3 weight % to about 6 weight %, based on the weight of titanium dioxide pigment before it is coated, of silica and about 1 weight % to about 4 weight %, based on the weight of titanium dioxide pigment before it is coated, of amorphous alumina.
